(19) United States
(12) Patent Application Publication
(10) Pub. No.: US 2013/0189510 A1
(43) Pub. Date: Jul. 25, 2013

(54) PRESSURE RESISTANT MATERIAL AND METHOD OF MANUFACTURING SUCH A MATERIAL

(71) Applicants: Andreas Echtermeyer, Hundhamaren (NO); Kristin Lippe, Oslo (NO)

(72) Inventors: Andreas Echtermeyer, Hundhamaren (NO); Kristin Lippe, Oslo (NO)

(73) Assignee: COMPBUOY AS, Trondheim (NO)

(21) Appl. No.: 13/817,095

(22) PCT Filed: Sep. 8, 2011
(86) PCT No.: PCT/NO2011/000240

§ 371 Date: Apr. 4, 2013

Related U.S. Application Data
(60) Provisional application No. 61/380,879, filed on Sep. 8, 2010.

(30) Foreign Application Priority Data
Sep. 8, 2010 (NO) 20101255

(51) Int. Cl. C08K 7/26

(52) U.S. Cl. CPC C08K 7/26
USPC 428/313.7; 427/221

(57) ABSTRACT

The invention is a pressure resistant material (22) for use under submerged conditions, comprising light expanded clay agglomerate beads (1) distributed in a matrix (21) of a polymer material (2)

### INTRODUCTION AND GENERAL BACKGROUND

The invention relates to a pressure resistant material for submerged use, and a method for manufacturing such a pressure resistant material. Such materials may be used for providing buoyancy to submerged equipment such as riser pipes, ROV vessels, or for providing thermal insulation to production pipes, production riser pipes, submarine petroleum pipelines, valve housings, and the like.

### BACKGROUND ART

A syntactic foam is a composite material synthesised by mixing micro-balloons of glass, carbon or polymer into a matrix of polymer, metal or ceramic. Syntactic foams with synthetic glass beads in filler material are widely used for underwater work down to hydrostatic pressures up to 1000 Bar, corresponding to depths of approximately 10000 m. However, the price of synthetic beads is very high and the manufacturing process is difficult. Different bead qualities may be manufactured with different depth ratings and the price generally increases with increasing depth rating.

UK patent GB769237 “Improvements in or relating to siloxane resin foams” describes a siloxane resin foam with a material called Kanamite. The Kanamite material is mentioned in the US patent U.S. Pat. No. 2,806,772 in Col. 2 lines 24-27 as individual small thin walled balloons of vitrified clay material described in U.S. Pat. No. 2,676,892, . . . marketed under the name “Kanamite”. Such material is prohibitively expensive to integrate in insulation materials for large marine structures such as risers and pipelines. The material of GB769237 may be said to be of second order as the syntactic material has two levels of gas-filled hollows; the siloxane resin with microbubbles as a foam of its own, the siloxane resin matrix foam also carrying glass microballoons .

Japanese patent publication JP6009972A describes a pressure resistant floating material combining a syntactic foam material with ceramic hollow members. The ceramic hollow members have a diameter of more than 20 mm are disposed in a mould and a syntactic foam material is filled in gaps so as to form a pressure resistant floating material. Also this publication may be said to describe a second order syntactic material as the matrix is a syntactic material as such filled between large ceramic hollow members.

UK-patent GB1153248 “Flotation unit for underwater instrumentation” describes a flotation means comprising a free flooding housing and a flotation structure within said housing consisting of a plurality of hollow spheres of inorganic nonmetallic material cast in a matrix of syntactic foam material. In page 2, lines 8-10 the material structure is described as “a float structure using the large spheres previously described cast in syntactic foam . . . ”. In lines 35-37 is described “a flotation structure utilizing the known advantages of the large thin-walled glass or ceramic spheres . . . ”. Large glass or ceramic spheres may withstand large hydrostatic pressures but a buoyancy material arranged about a riser pipe would not withstand mechanical shocks, particularly those imposed during handling during ship transport, deck handling, installation in the derrick, and in use. This UK-patent may also be said to be a second order syntactic material with syntactic foam carrying large spheres.

Japanese patent publication JP7304491A describes a buoyancy material similar to the above-mentioned JP6009972A with hollow ceramic bodies of size 5 to 15 cm in a light filler of fine hollow spherical bodies such as fine glass bubbles, and a polymer material such as polybutadiene rubber, having a binder function, and further describes a polyamide yarn for positioning the hollow ceramic spherical bodies in order to avoid contact between the relatively large hollow bodies. The polybudiadiene rubber is intended to form a cushioning material among the hollow ceramic spherical bodies. A rubber material would suffer from deformation and may be subject to shear deformation with an inherent risk of shear damage to the rather large hollow bodies and is thus not suitable for use as a deep sea buoyancy material for heavy structures such as risers.

Canadian patent CA1259077 describes fired hollow ceramic spheroids for use as fillers in concrete. It describes gas pipelines in the ocean wherein pipe sections have a metal core pipe covered with a concrete shell with spheroids within the concrete. The spheroids comprise a continuous phase of Aluminium Phosphate, Sodium Silicate, or Potassium Silicate, with an insolubilizing agent comprising a clay such as Kaolinite which combines with the continuous phase during firing to make the continuous phase insoluble in water. The resulting spheroids are mixed into concrete.

U.S. Pat. No. 5,218,016 to Jarrin et al. describes a filler and floatability material manufacturing process and tubular units that incorporate such material. The floatability material is an extruded admixture of thermoplastic resin and a load lightening material of hollow microspheres that resist against hydrostatic pressure. A twisted tubular unit is pultruded in thermoplastic resin with the hollow microspheres through a nozzle and collected on a drum.

U.S. Pat. No. 3,111,569 describes a variety of packaged laminated constructions wherein a material called “resin-bound aggregate materials of fire expanded clays” are mentioned in col. 2. The purpose is to make packaged ready-for-use components from which to make vessels, tanks, pipes or conduits that are able to float on water.

F. Bartl et al describe in “Material behaviour of a cellular composite undergoing large deformations”, Int. Journ. of Impact Engin, 13.12.2008, a syntactic foam with porous mineral granulates embedded in a cast polyamide matrix. The purpose is to test a material for its ability to absorbing crash impact energy at almost constant stress which is uniaxial, shear or hydrostatic. Granulate of porous mineral beads is filled into a mould and shaken to good grain contact and then all available remaining space is infiltrated from below with matrix material. The material, which is grain-born, starts collapsing under hydrostatic pressure at 10 MPa which is about 98 atmospheres, probably by bending and buckling of the cell walls, and damage of the granulates.

U.S. Pat. No. 6,886,304 “Multi-layer slab product made of stone granulates and relative manufacturing process”, describes a layer of dense agglomerated stone material in the form of granulates and a layer of expanded clay in an organic or inorganic binder material.

WO84/02489 Schmidt, “A building material for building elements, and a method and a system for manufacturing said elements”, describes a set of lower and upper conveyors carrying moulds for long building elements. The device comprises a particle feeder to the lower moulds and nozzles for premixed foam to the particles in the lower moulds. After injection the moulds pass past a compressing stage, a setting stage, a demoulding stage, and a cutter. The resulting building elements are plates, blocks, beams or columns consisting of a compressed hard particle filler held together by a foam plastic material. An example is perlite, an expanded volcanic hydrated glass, in polyurethane foam. The material described in page 2 contains 85-90% light expanded clay agglomerates and 15-10% polyurethane, please see lines 23-25. From page 2, lines 10-13, we cite “The filler is compressed so firmly in the mould that after the foaming the grains will still touch each other. This is the condition of obtaining high compression strengths.”, i.e. that the manufactured material is completely grain-borne. However, it is our experience that under high pressure, particle grains mutually crush each others surfaces. Water, if first having penetrated into the outer beads of the material wherein beads are in contact, the water will propagate and penetrate the beads in a flash-like pattern from bead to bead, thus such a material is not sufficiently pressure resistant to be used under submerged conditions in deep sea. When simply cut the final product will have random sections of beads which exposed on the surface, bead sections which, if used under submerged conditions, would become entry points for water.

Swedish patent publication SE466498B, “Fast-setting multicomponent mass, and a method for its manufacture and application”, forms priority for PCT patent publication WO92/07714. The WO publication describes a fast-setting multi-component composition for beams comprising 30-70% of expanded, burnt clay, 10-70% of polymer modified hydraulic cement based mortar, and 10-70% of fast-setting hydraulic cement based fibre reinforced mortar. The grain size of the expanded burned clay is 12 to 20 mm which is far too large for the present use as mentioned below with regard to pressure tolerance. The resulting mortar-based beams have a density of about 0.8 kg/m3, but their water absorbing properties under pressure, both with regard to mortar, nor beads, are unaccounted for. The expanded clay particles are mixed with a binder and enveloped in a layer of a given thickness which bind the grains in a porous macrostructure. A surface layer of mortar is then forced 10 to 15 mm into the surface of the porous macrostructure to seal the air-filled porous macrostructure, please see claim 5, item (c), a porosity which renders it useless for high-pressure appliances such as forming buoyancy elements for risers at large sea depths.

Beads of light expanded clay agglomerates may be used as a buoyancy material. L.e.c.a is expanded clay, a mineral foam full of gas-filled pores. It is a closed foam structure that entraps gas inside the pores in the beads.

Problems Related to the Use of l.e.c.a. as Buoyancy Material

The surface is not entirely smooth and some of the pores may be open at the surface of the bead, please see FIG. 1b. The shape of the pores may be rather irregular. Beads (1) of light expanded clay agglomerates, please see FIG. 1b, is a cheap and easily available material but unfortunately, it loses its buoyancy at a water pressure about 25 Bar, i.e. at a depth of about 250 metres in sea water. The weight of such l.e.c.a. beads increases with time, please see FIG. 1, which shows an increasing absorption of water from about 50 weight increase at 15 minutes, up to more than 75% weight increase after 60 minutes at 25 Bars.

Water enter the outer open pores easily but it is assumed that it does not penetrate the inner, closed pores of the beads without pressure. As a result the l.e.c.a. beads float in water. It is assumed that by increasing the water pressure the thin walls between pores may collapse, thus allowing water to propagate inwards. The bead will eventually lose its buoyancy and sink. This may explain the weight increase at 25 Bar. For this reason l.e.c.a. beads alone is not suitable for a deep-water buoyancy material, nor for a deep-water high-pressure insulation material.

Commercial l.e.c.a. beads available in dry bulk may have diameters ranging from 1 to more than 10 mm. The smaller beads have smaller pores and relatively thicker shells compared to the larger beads. This gives the smaller beads a higher density and a higher pressure resistance than larger beads, but possibly a too high density for use in the present invention. The inventors have found that beads between 2 and 4 mm have better collapse pressure, about 20 to 25 Bar, than bigger beads of 5-8 mm, which may not have sufficient pressure resistance.

Another problem related to 1.e.c.a. beads as a high-pressure buoyancy or insulation material is the fact that the beads are mechanically fragile, they easily crush upon bead-to-bead contact.

### Short Summary of the Invention

Some of the above problems may be remedied by the invention which is, in a first aspect, a pressure resistant material (22) for use under submerged conditions, comprising porous mineral beads (1) of light expanded clay agglomerates (12) distributed in a matrix (21) of a polymer material (2).

In an other aspect of the invention it is a method of manufacturing a pressure resistant material (22) for use under submerged conditions, comprising
providing porous mineral beads (1) of a light expanded clay agglomerates (11) in a polymer material (2);
forming a matrix (21) of said polymer material (2), said matrix (21) enveloping each and all of said porous mineral beads (1),
consolidating said matrix (21) with said porous mineral beads (1) to form said pressure resistant material (22).

By enveloping the 1.e.c.a. beads in a polymer matrix, their resistance to external water pressure is seen to be substantially increased. It is assumed that the polymer covers the bead surface. A polymer coating may fill the open, exposed outer pores and generally seal the l.e.c.a. bead. The present application presents several approaches to the structure of the polymer matrix and blocks of so-called “core material”, i.e. the high-pressure resistant material formed according to the invention.

Further advantageous embodiments of the invention are described below and defined in dependent claims attached.

### SHORT FIGURE CAPTIONS

FIG. 1 is an illustration of an embodiment of the invention and shows an imagined cut section of a pressure resistant material (22) according to the invention comprising a porous mineral material (11), here shown in the form of porous mineral beads (1), distributed in a matrix (21) of a polymer material (2). The beads (1) are preferably not in mineral grain contact. The material may be used for buoyancy, for subsea thermal insulation, or both.

FIG. 1b is a naked l.e.c.a. bead with internal closed, gas-filled pores and some open pores exposed at the bead's surface.

FIG. 1c is a diagram showing weight increase in percent versus time in minutes for un-coated l.e.c.a. beads in water at 25 Bar pressure.

FIG. 1d is a blow-up of a l.e.c.a. bead generally entirely enveloped in a matrix (21) of polymer material (2). The polymer matrix has intruded the surface exposed open pores of the bead.

FIG. 2 is an illustration of an a step in an embodiment of the method of the invention wherein the porous mineral material (11), in the form of porous mineral beads (1), is mixed with pellets (25) of polymer material (2) such as polypropylene (23) in a non-consolidated state, wherein the pellets shall be molten to be converted to form the matrix (21).

FIG. 3 illustrates an embodiment of the invention similar to the pressure resistant material (22) shown in FIG. 1, wherein the beads (1) are provided with a sealing layer (4) having low permeability to water. The sealing layer may also have low permeability to be the polymer material (2) even if the polymer material (2) should become viscous under high hydrostatic pressure.

FIG. 3b is an enlarged view of a l.e.c.a. bead of one of the beads from FIG. 3. The sealing polymer layer (4) is shown to have entered the open pores exposed at the surface of the bead (1) and generally seal the entire bead. The sealed bead is surrounded by polymer material (2) forming the overall matrix (21).

FIG. 4 is an illustration of an embodiment of the invention wherein an outer surface of a block (29) of the pressure resistant material (22) is covered in a water resistant membrane (3).

FIG. 5 is a cross-section of a lay-up according to an embodiment of the method according to the invention, comprising layers (101) of porous mineral material, here in the form of horizontal layers of porous mineral beads (1), interlayered with polymer material (2), here in the form of pellets (25), arranged in a mould or a container.

FIG. 6 illustrates a subsequent step in the process according to an embodiment of the invention wherein the lay-up of beads and thermoplastic material is heated from below for melting the thermoplastic from below and allowing bubbles to escape. Generally according to the invention vacuum is used to promote removal of bubbles in the resulting material. The layered mixed material is stabilized by being loaded by a force from above.

FIG. 7 illustrates a cross-section of a resulting block (29) of pressure resistant material (22) of the invention formed as shown in the preceding illustrations.

FIG. 8 is a cross-section of two or more such formed blocks (29) of pressure resistant material (22) of the invention stacked and sealed in a sealing material (33, 24) in a structurally supporting container (31).

FIG. 9 illustrates use of the pressure resistant material (22) of the invention wherein structurally supporting containers (31) shaped as buoyancy elements with the pressure resistant material (22) of the invention. Here the blocks of pressure resistant material are used as buoyancy for sections (66) of a riser (6). For a drilling riser, the pressure resistant material needs generally act as a buoyancy material, but for a production riser, the pressure resistant material should work also as thermal insulation.

FIG. 10 shows top and bottom images of two blocks of the pressure resistant material (22) of the invention wherein beads (1) are exposed on the surface of the block.

FIG. 11 shows an embodiment of a block of the pressure resistant material (22) of the invention wherein the block (29) is covered by a polymer membrane (3), here of polyethylene.

### DESCRIPTION OF EMBODIMENTS OF THE INVENTION

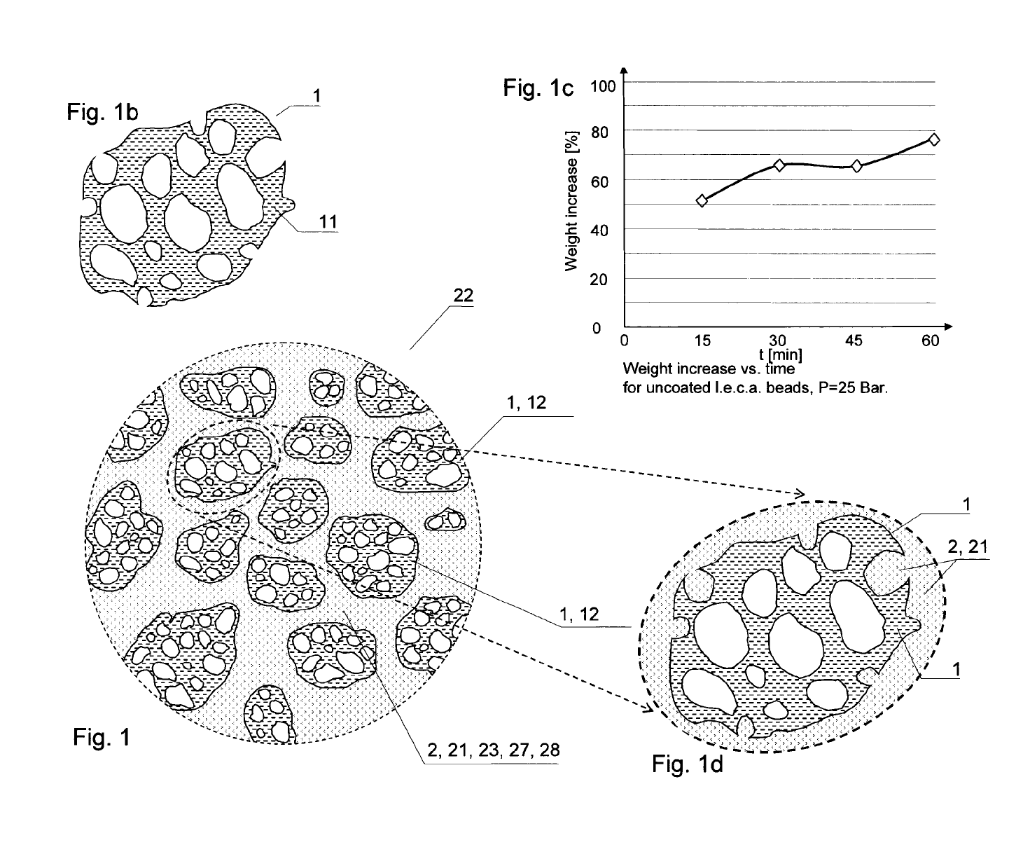

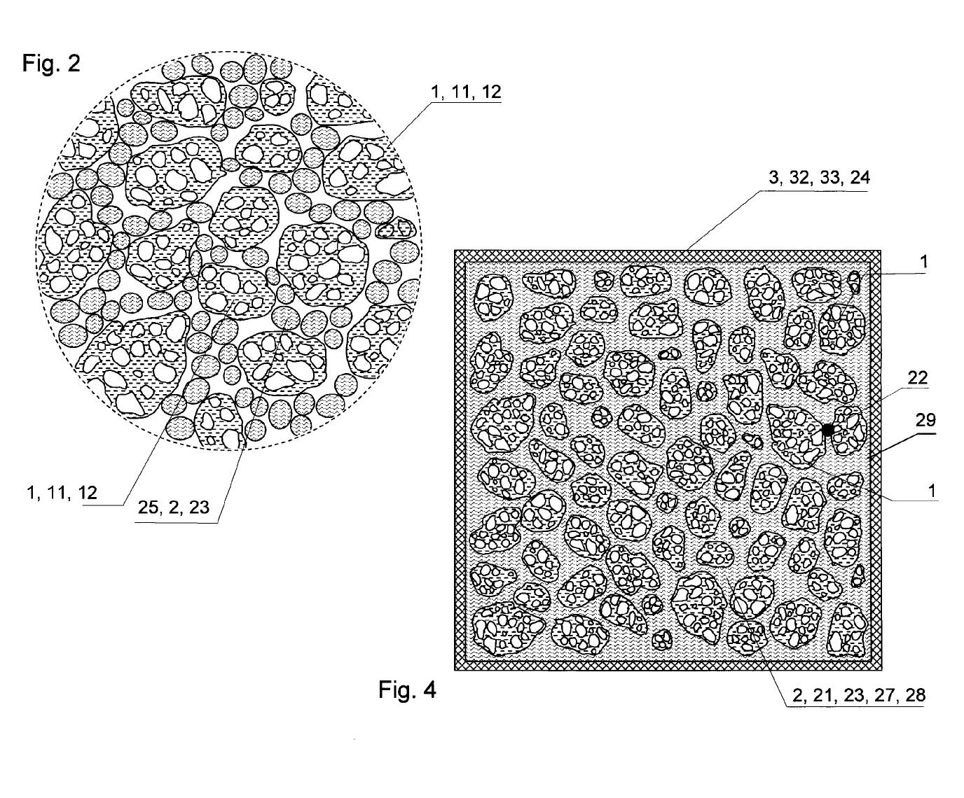

The invention is a pressure resistant material (22) for use under submerged conditions, comprising beads (1) of a porous mineral material (11), light expanded clay agglomerates, distributed in a matrix (21) of a polymer material (2), please see FIG. 1. The pressure resistant material (22) according to the invention may be used for providing buoyancy in water, or for being used as a thermally insulating material, or both, for marine equipment.

The pressure resistant material (22) according to the invention may withstand use at pressures up to 225 Bar or more, corresponding to sea depths at down to 2250 metres, or more. Experiments with test blocks of the material according to the invention have withstood pressure of 225 Bar in water for more than 1000 hours. The latest test conducted before filing of this application was 225 Bar for more than 1000 hrs, and was successful. Before the high pressure test one considered a risk of viscoelastic migration and intrusion of polymer into the voids of the beads but the 1000 hour test indicate that such viscoelastic intrusion is unlikely. Four of the samples that were subject to the 1000 hrs test at 225 Bar were made subject to a five minutes test at 300 Bar. There were no signs of damage to the samples or weight gain after this later test.

The pressure resistant material (22) of the invention may be contained in a structural support (31) such as a closed container or a cage of metal or a composite material. The pressure resistant material (22) in its structural support may be designed to be used as buoyancy elements for a petroleum drilling production riser or drilling riser pipe such as illustrated in the attached FIG. 9.

In an embodiment of the invention, the porous mineral material (11) is light expanded clay agglomerates in the form of porous mineral beads (1). The porous mineral beads (1) are enveloped in a matrix (21) of a polymer material (2), such as illustrated in FIGS. 1, 3, and 4. The porous mineral beads (1) may generally be of round or spherical shape so as for the shape of their crust shell itself to provide pressure resistance, adding to the pressure resistant properties of the mineral structure of the porous mineral material (11) as such.

In a preferred embodiment of the invention all the porous mineral beads (1) near an outer surface of said material (22) are entirely enveloped by said matrix (21), i.e. that no beads extend out of the matrix (21) at the surface of the material (22). This feature prevents water from intruding directly into grains at the surface of blocks (29) of the pressure resistant material. The pressure resistant material (22) of the invention has a weight gain due to water absorption of maximally 20% under its highest pressure rating, say 200 Bar, over the expected operating time of the material, on the order of 1 to 10 years. At present, some successful tests with a duration of 1000 hours are well under this water absorption limit.

In an embodiment of the invention the polymer material (2) which constitutes the matrix (21) of the high-pressure material is essentially free of voids. This is important in order to avoid structural deformations in the matrix and thus damage to the high pressure resistant material (22) when subject to high pressure.

In an advantageous embodiment of the invention, the matrix (21) is formed and consolidated under vacuum. This is an efficient way of essentially reducing the occurrence of void-forming bubbles in the matrix (21), and is expected to increase the high-pressure tolerance of the pressure resistant material of the invention.

The porous mineral material (11) is in the form of porous mineral beads (1) as illustrated throughout.

The pressure resistant material (22) of the invention may be used for providing buoyancy to submerged equipment such as drilling riser pipe elements, production riser pipe elements so as for reducing the load from the riser on the supporting platform, and also for reducing internal weight load in the riser's mechanical structure. Further, the pressure resistant material (22) may be used for providing buoyancy to ROV vessels.

Samples of the pressure resistant material (22) has a thermal conductivity of less than (0.5+/−0.15) W/mK or less and may be used in order to provide thermal insulation. Polyethylene as the polymer (2) may not have sufficiently low density to provide buoyancy but will provide a core material having thermal insulation properties. For thermal insulation the pressure resistant material (22) may be used on production pipes, riser pipes, riser hoses, valve housings and other submerged equipment so as for reducing heat loss from production fluids. Some subsea uses may benefit from both the buoyancy and thermal insulation properties of the pressure resistant material (22) of the invention, such as for production risers. The pressure resistant material (22) should have a density less than that of water, particularly less than sea water. For other purposes such as for thermally insulating valve housings, the density of the pressure resistant material (22) need not be less than that of water. A heavier material also helps to keep pipes and subsea equipment stable on the bottom.

In a preferred embodiment of the invention the pressure resistant material (22) may have an operating temperature up to 80° C., and should preferably withstand temperatures up to between 110° C. and 150° C.

The pressure resistant material (22) of the invention should have a long-term water absorption under high pressure submerged conditions less than 20%, more preferably less than about 10%.

The density of the pressure resistant material (22) may be controlled through the material density of the porous mineral material (11), the density of the polymer material (2), and the proportion of porous mineral material (11) to polymer material (2). If the overall density of the pressure resistant material (22) is less than that of water, buoyancy will be provided. If used for thermal insulation the overall density of the pressure resistant water needs not be less than that of water.

The polymer material (2) used may be a thermoplastic material such as polypropylene (23) (a low cost, low density material) or its copolymers, polyethylene, polytetrafluroethylene or other thermoplastic material. The polymer material (2) may alternatively comprise a thermoset material (27) such as polyurethane, polyester, an epoxy (28), or other thermoset material.

In an embodiment of the invention the mineral material (11) comprises light expanded clay agglomerates (12). Such light expanded clay agglomerate beads have a density rhol of about 0.600 g/cm³.

Porous mineral beads (1) of light expanded clay agglomerate (12) as such may withstand a pressure of about 20 Bar before they collapse. Smaller diameter beads have typically higher density and higher crushing strength than larger diameter beads. Mixing beads of different diameters is envisaged. If light expanded clay agglomerate beads (12) are distributed according to the invention in a matrix (21) of a polymer material (2) to form a pressure resistant material (22), it has been discovered in laboratory experiments that the hydrostatic pressure tolerance of the beads increases significantly. Using polypropylene (23) with a density of about 0.800 g/cm³ as the matrix-forming polymer material (2) and light expanded clay agglomerates (12), having a combined density of about 0.700 g/cm³ will provide good buoyancy.

In an embodiment of the invention the porous mineral beads (1) generally have a diameter of 2 to 4 mm, which is the best mode found during experiments: larger beads 5 to 8 mm may break down more easily, smaller beads are too heavy.

Pressure resistance may in the present context be defined as the property that hydrostatic pressure will not result in water intrusion or structural collapse of the material. Blocks of this composition have been further enveloped in a water resistant membrane (3), in this example comprising a second polypropylene (24) and withstand a hydrostatic pressure of 225 Bar, which corresponds to a depth of more than 2250 metres. If the hydrostatic pressure is increased beyond the pressure tolerance of the material, experiments have shown that cracking may initiated in the porous mineral beads (1) which are closest to the surface of the block of pressure resistant material (22). Such cracks may propagate in the porous beads further towards the interior of the pressure resistant material forming a braided pattern towards the interior.

In a preferred embodiment of the invention, the outer waterproof membrane (3) (membrane with very low water permeability under high pressure) is formed under vacuum on said one or more of said blocks (29) of said pressure resistant material (22). The membrane (3) of very low permeability for water may be formed under vacuum injection or other forming under vacuum, such as applying a thermoplastic polymer powder on the surface of said blocks (29) and melting and consolidating it under vacuum.

The polymer material (2) may as such form a barrier against water intrusion to the porous mineral material (11). In a preferred embodiment of the invention the polymer material (2) forming the matrix (21) must entirely enclose the l.e.c.a. beads. In an embodiment of the invention a further barrier against water intrusion is formed by arranging a water resistant membrane (3) on the surface of blocks of the pressure resistant material (22). Such an embodiment is illustrated in FIG. 4. The material of the water resistant membrane (3) may comprise a second polymer material (32). The second polymer material (32) of the water resistant membrane (3) may be a second polypropylene layer (24), a polyethylene layer, a polyester layer, or an epoxy layer (33). The water resistant membrane (3) may also be embodied as a foil, a continuous metal sheet, or by applying rubber.

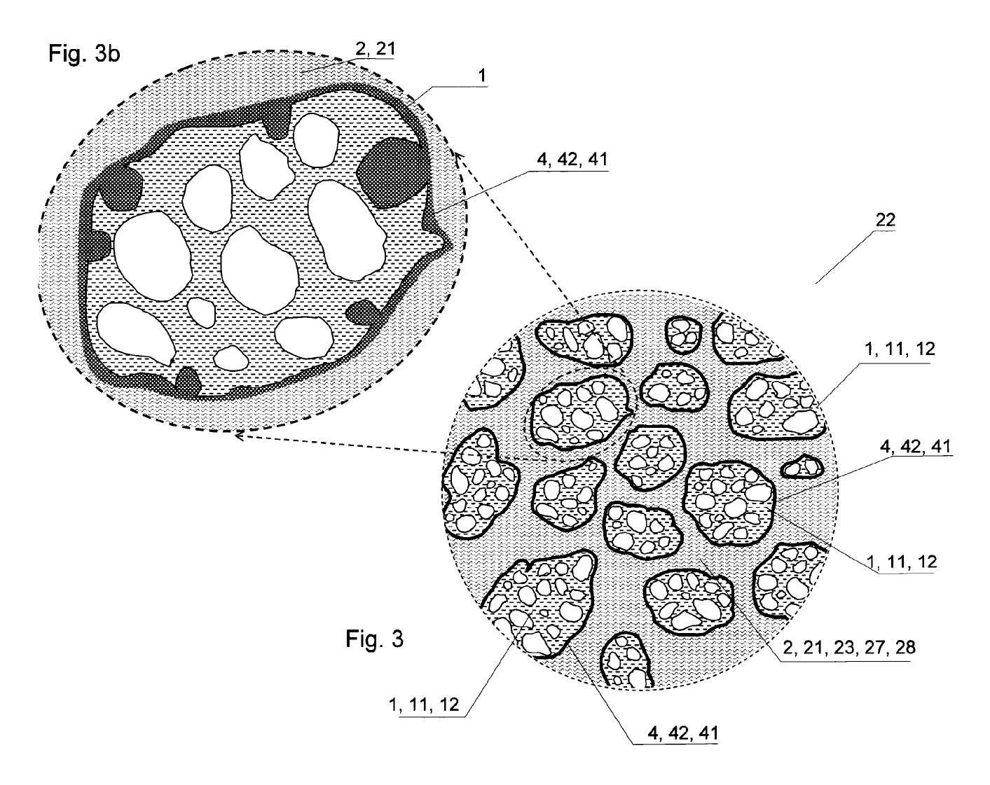

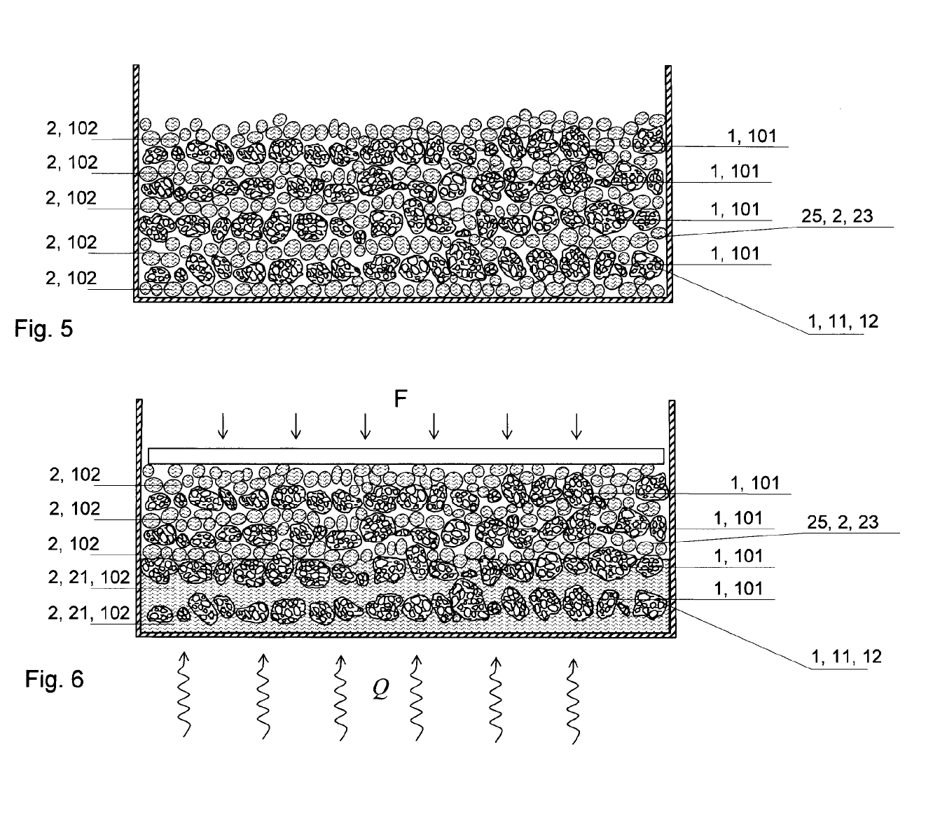

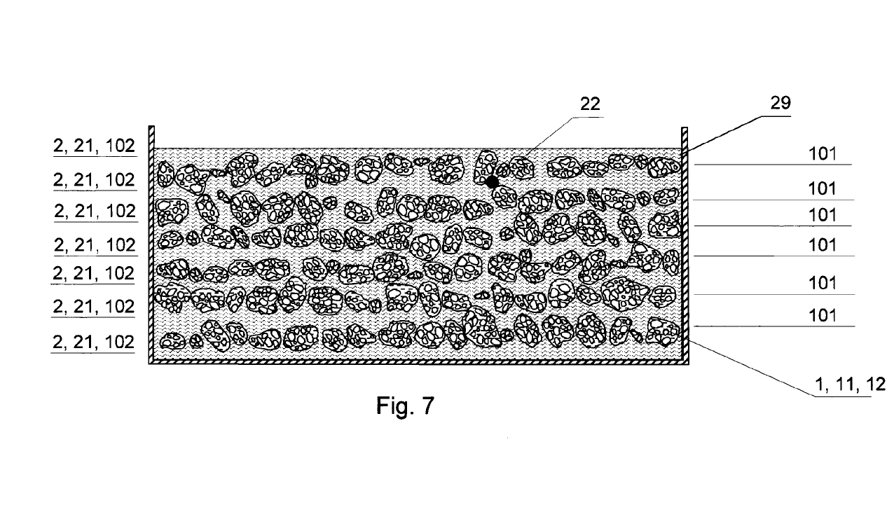

There is a risk that under high pressure polypropylene may become viscous under high pressure and penetrate the surface of porous mineral beads (1), as seen on a micro level. It is also assumed that there is a risk that under elevated temperature polypropylene may become viscous under high pressure and penetrate the porous mineral beads (1) surface, as seen on a micro level. According to an embodiment of the invention the porous mineral material (11) comprises a surface sealing layer (4) of very low permeability to water and of very low permeability to the bulk polymer material (2), please see FIG. 3. The presence of the surface sealing layer (4) for the beads (1) may improve the pressure resistant properties of the material (22). The surface sealing layer (4) for the beads may comprise hardened epoxy (41), a polypropylene of higher melting temperature than polypropylene otherwise used in the polymer material (2), polyester, vinylester, in general a material which prevents water or the polymer material (2) from intruding, into the porous mineral beads (1) when the material is subject to high pressure. Another advantage of the surface sealing layer (4) is to prevent contact propagation of concentrated pressure from bead to bead, in order to prevent propagation of cracks in the buoyant material.

The surface layer (4) create some distance between the mineral surfaces of each adjacent pair of beads to significantly reduce the degree of mutual bead contact.

Bead to bead mineral contact should be avoided in order to avoid crushing of beads upon pressure increase. This may be achieved by adjusting the bead to matrix-forming material ratio in order to have a surplus of matrix-forming polymer material (2) to create some separation between generally all beads, please see FIG. 1, or by using a surface sealing layer (4) as described above. The polymer material (2) or the sealing layer (4), please see FIG. 1, 2 or 4, will also separate the beads (1) and distribute the contact forces that otherwise would occur from grain to grain and thus avoid crushing.

Advantageously, the said surface layer (4) is applied and consolidated under vacuum. In an embodiment of the invention the surface sealing layer (4) is thermoplastic and has a higher melting temperature than the bulk of said matrix material (21).

Vacuum is important : In order to improve the quality of the coating of the beads by the surface layer (4) to be without voids the surface layer (4) may be formed under vacuum.

The surface sealing layer (4) may comprise a polypropylene layer (42) or a polyethylene layer (43) preferably of higher melting temperature than the bulk of the bulk matrix material (21) of the polymer material (2). Melting temperatures may be as follows: for coating around bead: highest , e.g. 225° C., for matrix (21) of the core material: high, e.g. 210° C., and for the polymer of outer membrane, lower, e.g. 120° C.

The pressure resistant material (22) may be arranged on a subsea device such as a subsea pipeline, a riser pipe, or a valve housing, by arranging the pressure resistant material (22) in a structural support (31) mounted onto the subsea device, or by being applied by spraying or extrusion and consolidation directly onto a subsea device. For a riser pipe, the pressure resistant material (22) must provide buoyancy. For a production riser pipe, the buoyant pressure resistant material (22) of the invention has typically an advantage if it is also thermally insulating.

General Structure and Properties of the Invention

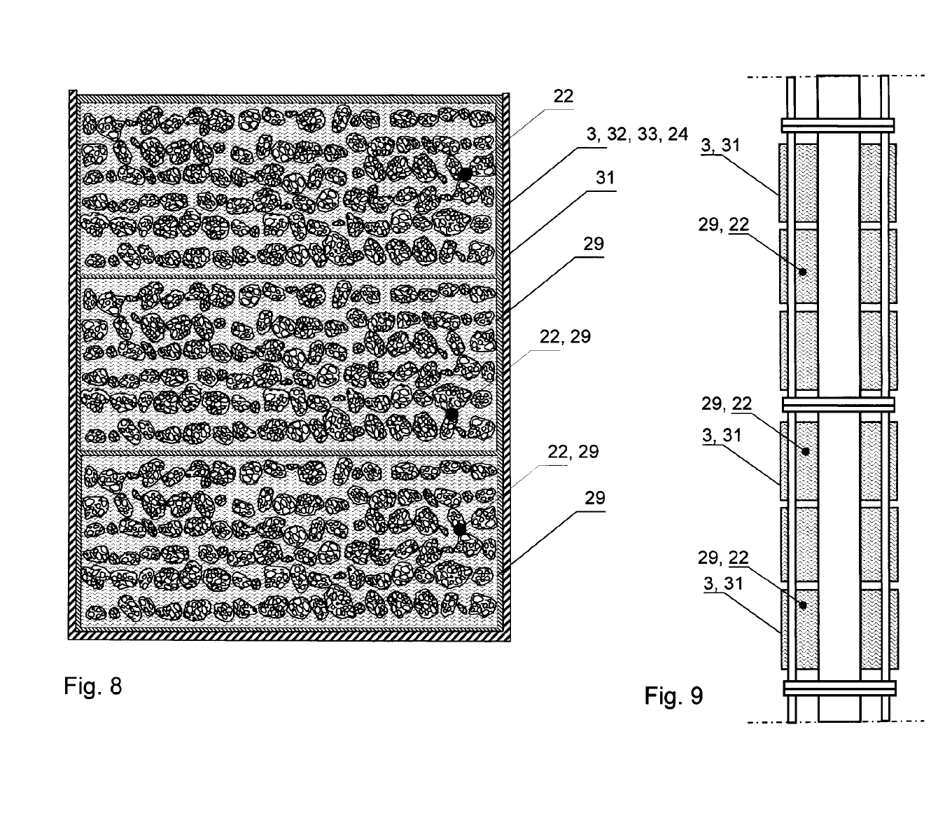

The pressure resistant material (22) comprising porous mineral beads (1) in polymer material (2) provides pressure resistance as such. The porous mineral beads (1) may be improved with regard to pressure resistance in several independent ways. One way is by sealing the beads with a sealing layer (4), i.e. on a grain scale. In general, the polymer matrix forms a matrix for the beads, it prevents water intrusion to the beads, it prevents grain to grain contact, and it distributes stress. Independent of the bead sealing layer (4), manufactured blocks (29) of the pressure resistant material (22) of the invention may be water-proofed by covering the pressure resistant material by a water resistant membrane (3). In this way, the pressure resistant material (22) may be sealed against water intrusion, in case the polymer material (2) should not be sufficiently low-permeable to water under high pressure. Water intrusion to the beads may thus be prevented at several levels. Independent of the presence of the water resistant membrane (3) or individual bead sealing layer (4), blocks of desired shape may be arranged in a water resistant structural support (31), not necessarily closed, for mounting on subsea equipment. As an example, for use as drilling riser support elements, such blocks may be formed in half cylinder blocks with bore for the riser and kill and choke lines, and arranged in corresponding container elements for being mounted onto either sides of the riser element, please see FIG. 9. The blocks (29) of the pressure resistant material (22) may be immersed in polymer material filling voids and locking and possibly forming the water resistant membrane (3) on the elements within the structurally supporting container (31), as illustrated in FIG. 8.

On the Manufacture of the Pressure Resistant Material of the Invention

The pressure resistant material (22) for use under submerged conditions may generally be produced according to the following steps:
providing porous mineral beads (1) of light expanded clay agglomerates (11) in a polymer material (2);
forming a matrix (21) of said polymer material (2), said matrix (21) enveloping each and all of said porous mineral beads (1);
consolidating said matrix (21) with said porous mineral beads (1) to form said pressure resistant material (22).

Light expanded clay agglomerates (12) is used for being comprised in the porous mineral material (11) in the form of porous mineral beads (1). In one embodiment of the invention, the porous beads (1) may be distributed in pellets (25) of the polymer material (2) by mixing in a blender.

In general the forming of the matrix (21) is by providing the polymer material (2) in liquid or molten form at a stage, for subsequently consolidating the fluid polymer material (2) to a solid matrix (21).

According to an embodiment of the method of the invention, porous mineral beads (1), are arranged in the polymer material (2) by having first layers (101) of the porous mineral beads (1) alternating with second layers (102) of said polymer material (2) in the dry state, please see FIG. 4, for subsequently melting said dry polymer material (2) to its molten form, for subsequently consolidating said matrix (21). The polymer material (2) used in the process may be pellets (25) of a thermoplastic material. The pellets (25) may be melted by heating. The heat generated in an extruder may be sufficient to melt the thermoplastic. At least the pellets comprising the polymer material (2) should be heated and subsequently cooled to form the matrix (21). The lay-up in the surrounding mould may preferably be heated from below in order to allow air to escape from the melting lay-up, and to prevent formation of voids in the pressure resistant material (22). The process described above may remedy the issue of low viscosity of polypropylene which may prevent good penetration in between the porous mineral beads (1). Instead of providing pellets (25) of thermoplastic material, sheets or cloths of thermoplastic material or even sprayed molten material on the porous mineral material layers (101) may be applied. In order to prevent migration and even flotation of the porous mineral beads (1) in molten polymer material (2) mechanical restraint may be applied to the lay-up, here illustrated as a weight arranged on top of the lay-up as seen in FIG. 6. Experiments during this layup-method have shown that if the layup is generally shaken once in a while during the process, a higher packing density and thus improved material quality is achieved. This flooding from below may to some extent avoid voids in the matrix between the beads. If the process is run under vacuum, undesired voids and bubbles in the resulting core material, i.e. the pressure resistant material (22) may be further avoided, thus reducing internal deformation under high pressure.

Another way of obtaining a void-free pressure resistant material (22) is to form the material under vacuum injection of the polymer (2).

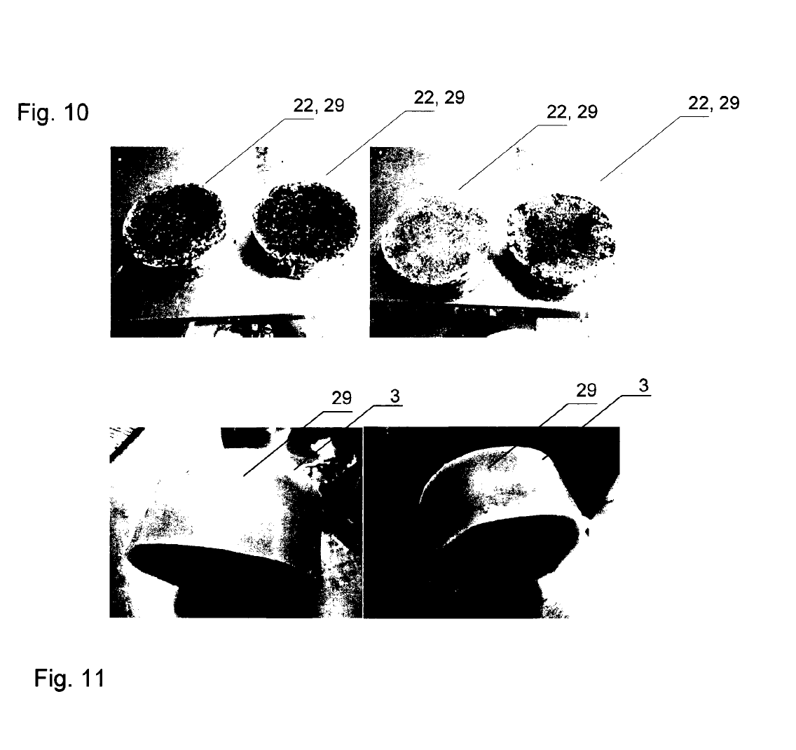

The pressure resistant material (22) may be moulded or formed in one or more blocks (29) of required shape and size depending on its use. It is important for the pressure resistance of the material (22) that all porous mineral beads in the resulting block (29) of core material (22) are entirely enveloped by said matrix (21), i.e. that no beads extend out of the matrix (21) at the surface of the material (22). This feature prevents grains from being directly exposed to water which may otherwise intrude directly into grains at the surface of blocks (29) of the pressure resistant material (22). FIG. 10 shows top and bottom images of two blocks of the pressure resistant material (22) of the invention and is a good example of a block with beads (1) are on the surface of the block. Preventing exposure of the beads may be achieved by first moulding a block (29) using a polymer (2) and then moving the block to a slightly larger mould and adding more of the same polymer (2) to form a membrane (3) of the same polymer material. The membrane forming material (4) may be a polyethylene, polypropylene, an epoxy, a polyester, or a vinylester. The membrane (3) may thus form an additional waterproofing barrier on the block (29) in addition to the core matrix (21) forming polymer (2), or seal off grains that otherwise would be exposed. The thickness of the membrane should be adapted accordingly.

In an embodiment of the invention the formation of the resistant membrane is conducted by applying polyethylene powder on blocks (29) and melting the polyethylene powder to form the water resistant membrane (3), please see FIG. 11 of an example of a block (29) of the buoyancy material with an outer polyethylene membrane (3). Samples of this quality did not change weight significantly during the 225 Bar/1000 hours test, and with the only deformation observed being some slight dents in the surface of the membrane (3). Four of the samples that were subject to the 1000 hrs test at 225 Bar were made subject to a five minutes test at 300 Bar. Three of these samples were made from l.e.c.a. beads (1) in polypropylene without vacuum during formation of the matrix, and provided with two membrane (3) layers of polyethylene powder molten under vacuum. In the fourth sample that was made subject to this test the core was made from l.e.c.a. beads in polypropylene matrix without using vacuum, and the surface membrane was formed from polypropylene pellets molten under vacuum.

Advantageously the water resistant membrane (3) is formed under vacuum.

In an embodiment of the invention, the matrix (21) with the porous mineral beads (1) is formed by extruding a mixture of porous mineral beads (1) and thermoplastic material through an extruder nozzle. In such a situation the beads (1) could advantageously be coated by a surface sealing layer (4) in order to protect the beads and even the nozzle. Alternatively a compounding machine may be used. The extrusion process may provide heat sufficient to melt thermoplastic polymer material.

In an embodiment of the invention, the polymer material (2) matrix (21) of the pressure resistant material (22) may be formed by resin infusion into a light expanded clay agglomerate lay up arranged in a vacuum mould, and curing the resin to consolidate to form the matrix. Also here, the process should advantageously be conducted under vacuum in order to prevent formation of voids in the matrix.

Generally the porous mineral beads (1) should not be in mutual non-bead-to-bead mineral contact. This may be achieved by covering generally each piece porous mineral bead (1) with the surface sealing layer (4) impermeable to said polymer material (2) before the step of distributing said porous mineral beads (1) in said polymer material (2). This will assure the material (22) to be polymer-borne, no bead-to-bead contact.

In an embodiment of the invention the sealing surface layer (4) is made of Polypropylene or polyethylene.

As mentioned previously, it is important forming the matrix polymer material (2) of said matrix (21) as such essentially free of voids in the polymer material. One way of obtaining a void-free polymer of the matrix (21) is forming and consolidating the matrix-forming polymer material (2) of the matrix (21) under vacuum. This may be done under vacuum injection in a vacuum mould or under a vacuum bag.

The bead sealing layer (4) may be made of a second epoxy (41) This step may be conducted by running porous mineral beads (1) in a liquid of the second epoxy (41) in a running force blender while said epoxy (41) is allowed to cure to form the bead sealing layer (4) as a membrane or shell.

If the 1.e.c.a. beads (1) are provided with a sufficiently thick and non-water-permeable coating (4), an outer membrane (4) may not be required in order to provide sufficient waterproofness under high pressure submerged conditions. This would have the advantage that all parts of the buoyancy material (22) would be independently pressure resistant.

1.-49. (canceled)

50. A pressure resistant material for use under submerged conditions, said pressure resistant material shaped in one or more blocks covered by one or more membranes of very low permeability to water, comprising
porous mineral beads of light expanded clay agglomerates,
said porous mineral beads being generally of rounded or spherical shape and having a diameter of 1 to 8 mm and distributed in a matrix of a polymer material,
said porous mineral beads generally not in bead-to-bead contact,
wherein all porous mineral beads near an outer surface of said material are entirely enveloped by said matrix,
said pressure resistant material withstanding a hydrostatic pressure of 200 Bar or more for 1000 hours.

51. The pressure resistant material of claim 50, said porous mineral beads comprising a surface sealing layer of very low permeability to said polymer material.

52. The pressure resistant material of claim 51, said surface layer consolidated under vacuum.

53. The pressure resistant material of claim 51, said surface sealing layer being thermoplastic and having a higher melting temperature than the bulk of said matrix material.

54. The pressure resistant material of claim 53, said surface sealing layer comprising a polypropylene layer or polyethylene layer preferably of higher melting temperature than the bulk of said matrix material of said polymer material.

55. The pressure resistant material of claim 50, said polymer material being a thermoplastic.

56. The pressure resistant material of claim 55, said polymer material comprising polypropylene or its copolymers.

57. The pressure resistant material of claim 50, said polymer material comprising a thermoset material such as a first epoxy in said polymer material.

58. The pressure resistant material of claim 50, having a density less than that of water, particularly of seawater.

59. The pressure resistant material of claim 50, said pressure resistant material having a thermal conductivity of less than (0.5+/−0.15) W/mK.

60. The pressure resistant material of claim 50, said polymer material comprising polyethylene or its copolymers.

61. The pressure resistant material of claim 50, one or more blocks arranged in a structural support and mounted onto a subsea device such as a riser pipe, the pressure resistant material providing buoyancy.

62. The pressure resistant material of claim 50, one or more of said blocks arranged on a subsea device such as a subsea pipeline, a valve housing, the pressure resistant material being thermally insulating.

63. A method of manufacturing a pressure resistant material for use under submerged conditions, comprising
providing porous mineral beads of light expanded clay agglomerates in a polymer material;
forming a matrix of said polymer material, said matrix enveloping each and all of said porous mineral beads, said porous mineral beads generally not in mutual non-bead-to-bead mineral contact,
forming said pressure resistant material in one or more blocks,
consolidating said matrix with said porous mineral beads to form said blocks of pressure resistant material
covering one or more of said blocks of said pressure resistant material with one or more layers of water resistant membrane.

64. The method of claim 63, forming said matrix by providing said polymer material in molten form, for subsequently consolidating said matrix.

65. The method of claim 63, forming said matrix by providing said polymer material in dry state, melting said dry polymer material to its molten form, for subsequently consolidating said matrix.

66. The method according to any claim 63, comprising a step of sealing generally each said porous mineral bead with a surface layer, said sealing surface layer preferably made of polypropylene, before distributing said porous mineral beads in said polymer material.

67. The method of claim 66, comprising forming said bead sealing layer of epoxy and allowing said second epoxy to harden.

68. The method of claim 66, comprising forming said surface sealing layer of a thermoplastic having a higher melting temperature than the bulk of said matrix material, such as of polypropylene or polyethylene.

69. The method according to claim 63, distributing said porous mineral beads in said polymer material by arranging first layers of said porous mineral beads alternating with second layers of said polymer material, and melting and consolidating said polymer material to form said matrix.
